(19) United States
(12) Patent Application Publication
(10) Pub. No.: US 2011/0122609 A1
(43) Pub. Date: May 26, 2011

(54) CUSTOMIZABLE TORCH

(76) Inventor: Flemming Dahlin, Graested (DK)

(21) Appl. No.: 12/674,681

(22) PCT Filed: Aug. 25, 2008
(86) PCT No.: PCT/DK08/00302

§ 371 Date: Sep. 15, 2010

(30) Foreign Application Priority Data
Aug. 23, 2007 (DK) PA 2007 01207

(51) Int. Cl. F21L 4/02; B65D 71/00

(52) U.S. Cl. 362/184; 206/223

(57) ABSTRACT

The present invention provides a compact, portable light sour-ce (1), preferably sized to be readily hand-held, for illuminating an object, several objects, or areas for human use and/or machine operation. The function of the portable light source (1) is controlled by a first microprocessor (51) located inside the portable light source. The first microprocessor (51) is externally accessible either through a direct link to an external control unit (54) or through a link involving one or more other microprocessors located in accessible positions of the portable light source. The function can hence be customized by the user himself to any given situation making the portable light source especially suitable for professional use, i.e. for security, police and military use.

All patent and non-patent references cited in the present application, are also hereby incorporated by reference in their entirety.

### FIELD OF INVENTION

The present invention relates to an illumination apparatus and light emitting diode (LED) lamp controlled by an externally accessible microprocessor allowing the user to customize the functionality of the illumination apparatus.

### BACKGROUND OF INVENTION

A flashlight usually is used by families for emergency occasions or by maintenance personnel to work on a dark working site or military personnel, policemen or even security guards. Especially for professional use it is relevant that the flashlight provides an effectful lightbeam having a long-distance visibility as well as being waterproof and easy to handle. The owner/user of the flashlight often wishes to use it in a large variety of situations which each requires a different performance and functionality of the flashlight.

### SUMMARY OF INVENTION

The present invention provides a compact, portable light source, preferably sized to be readily hand-held, for illuminating an object, several objects, or areas for human use and/or machine operation. The portable light source is capable of providing powerful light as well as effect light as discussed below. The function of the portable light source is controlled by a first microprocessor located inside the portable light source. The first microprocessor is externally accessible either through a direct link to an external control unit or through a link involving one or more other microprocessors located in accessible positions of the portable light source. The function can hence be customized by the user himself to any given situation making the portable light source especially suitable for professional use, i.e. for security, police and military use.

Accordingly, in one aspect the present invention relates to a portable torch having at least one light emitting unit (LEU), a first microprocessor, and a second microprocessor, namely a portable torch comprising
a case having a first end and a second end, and a first cap having a transparent area,
illumination means having an illumination area comprising at least one light emitting unit (LEU) arranged to emit light through the transparent area of the first cap,
a power source comprising a battery holder,
means for activating said power source
at least a first microprocessor and a second microprocessor
   wherein the first microprocessor comprises means for controlling the functionality of the torch, means for communicating with other microprocessors such as said second microprocessor, and means for storing received program settings and data from said other microprocessors, and wherein the second microprocessor comprises communicative means for communicating with said first microprocessor and communicative means for communicating with at least one external control unit.

In another aspect the present invention relates to a portable torch wherein a first microprocessor is directly accessible and programmable from at least one external control unit, namely a portable torch comprising
a case having a first end and a second end, and a first cap having a transparent area,
illumination means having an illumination area comprising at least one light emitting unit (LEU) arranged to emit light through the transparent area of the first cap,
a power source comprising a battery holder,
means for activating said power source,
at least a first microprocessor comprising means for controlling the functionality of the torch, means for communicating with at least one external control unit, and means for storing received program settings and data from said external control unit
   wherein the functionality of the torch is determined by the settings and programs of said first microprocessor.

In a third aspect the present invention relates to a portable torch comprising
a case having a first end and a second end, wherein said first end is open and covered by a releasably locked head, said releasably locked head having a transparent area,
illumination means having an illumination area comprising at least one light emitting unit (LEU) arranged to emit light through the transparent area of the releasably locked head,
a power source comprising a battery holder,
means for activating said power source,
at least a first microprocessor comprising means for controlling the functionality of the torch,
   wherein said releasably locked head comprises rotation preventing means that essentially prevents rotation of the releasably locked head relative to the case around the longitudinal axis of the case when the releasably locked head is locked onto or released from said case.

In a fourth aspect the present invention relates to a portable torch that maintains a comfortable temperature on said first cap or releasably locked head during use, namely a portable torch comprising
a case having a first end and a second end, and a first cap having a transparent area,
illumination means having an illumination area comprising at least one light emitting unit (LEU) arranged to emit light through the transparent area of the first cap,
a power source comprising a battery holder,
means for activating said power source,
at least a first microprocessor comprising means for controlling the functionality of the torch,
   wherein the outer parts of said first cap are made in a material that exhibits a low thermal conductivity.

In a fifth aspect the present invention relates to a portable torch equipped with additional means for adjusting the ligthbeam exiting the torch, namely a portable torch comprising
a case having a first end and a second end, and a first cap having a transparent area,
illumination means having an illumination area comprising at least one light emitting unit (LEU) arranged to emit light through the transparent area of the first cap,
a power source comprising a battery holder,
means for activating said power source,
a removable cover encasing at least the transparent area of said first cap or said releasably locked head providing means for arranging means for adjusting the optical properties of a light beam emitted out through the transparent area of said first cap or said releasably locked head.

In a sixth aspect the present invention relates to a portable torch, wherein the firs cap is connected to the case through a flexible cable, namely a portable torch comprising
a case having a first end and a second end, and a first cap having a transparent area,
illumination means having an illumination area comprising at least one light emitting unit (LEU) arranged to emit light through the transparent area of the first cap,
a power source comprising a battery holder,
means for activating said power source,
a flexible cable capable of connecting the first cap to the case.

All the aspects discussed herein may be combined with one or more of the various embodiments discussed below. The present invention further relates to a modular kit comprising a portable torch, as defined above, and at least one second battery-driven device, wherein said second battery-driven device is capable of being connected to the portable torch for sharing battery with the portable torch or wherein a cap comprising a diode area of the second battery-driven device is capable of being connected to the portable torch.

In yet another aspect the invention relates to a battery-driven device, said battery-driven device being adapted for connecting a portable torch as defined above for sharing battery with the portable torch or wherein a cap comprising a diode area of the second battery-driven device is capable of being connected to the portable torch.

### DESCRIPTION OF THE DRAWINGS

FIGS. 1a, 1b and 1c show a portable torch according to the invention.

FIGS. 2a and 2b show the transparent area of one embodiment of the first cap or releasably locked head of the portable torch with recesses comprising lenses.

FIG. 3 shows the diode area of the portable torch.

FIG. 4 shows the heat sink of the portable torch according to the invention.

FIG. 5 shows the heat sink connected to the power source.

FIG. 6 shows the inner torch assembly.

FIGS. 7a, 7b and 7c show an alternative portable torch according to the invention.

FIGS. 8a and 8b show the transparent area of the first cap of the portable torch of FIG. 7 with recesses comprising lenses.

FIG. 9 shows the diode area of the portable torch of FIG. 7.

FIG. 10 shows the inner torch assembly of FIG. 7.

FIG. 11a shows tail-light socket with connector connected without transparent cap, and FIG. 11b shows the same with attached transparent cap.

FIG. 12 shows the portable torch according to the invention with cable for connecting tail-light.

FIGS. 13a and 13b show alternative embodiments of a cross section of a heat sink.

FIG. 14a shows the switch arrangement of the portable torch, FIG. 14b shows a switch in greater detail, FIG. 14c shows the switch during valve ventilation, and FIG. 14d shows the switch arrangement adjacent to a magnet.

FIG. 15a shows a case for a battery-driven device having one open end.

FIG. 15b shows a switch area for a battery-driven device having one open end.

FIG. 15c shows a cap comprising a diode area adapted to fit into the open end of the case in FIG. 15a.

FIG. 16a shows a torch having a releasably locked first cap.

FIG. 16b shows the first cap of FIG. 16a in a locked position.

FIG. 16c shows the first cap of FIG. 16a in an un-locked position.

FIG. 17 shows an alternative embodiment of the torch according to this invention.

FIG. 18a shows the torch having a first and a second microprocessor

FIG. 18b shows the torch of FIG. 18a further featuring an Infrared port and a connectable unit comprising a microprocessor.

FIG. 18c shows the first cap of the torch of FIG. 18a, wherein the first cap is mounted to be programmed.

### DETAILED DESCRIPTION OF THE INVENTION

The present invention relates to a portable torch for handheld portable illumination having several features and capable of having several functions that is to be explained in the following.

The portable torch according to the present invention may have at least one of the following features and/or functions:
Powerful light effect
Waterproof case
Flashing effect
Tail-light
Function as battery tank
Comfortable temperature on the cap or releasably locked head from which the lightbeam is emitted
Programmable and user customizable light functions
Cover with optics for adjusting the light beam

The features and functions are described in more detail in the following. In the present context, upwards or upper means towards the first end of the portable torch, whereas downwards or lower means towards the second end of the portable torch.

In a preferred embodiment, the portable torch comprises a case wherein the first end is open and covered with a releasably locked head which has a transparent area. The releasably locked head and the inner torch assembly comprise inter-related rotation preventing means that essentially prevents rotation of the releasably locked head relative to the case around the longitudinal axis of the case when the releasably locked head is locked onto or released from said case. Thereby any excessive twisting of the releasably locked head relative to the inner torch assembly is avoided. Such twisting could potentially result in serious damage to any wires connecting units in the releasably locked head with units in the inner torch assembly.

The outer part of the releasably locked head is fabricated in a material that exhibits a low thermal conductivity thereby ensuring that the releasably locked head maintains a temperature which is comfortable for the user. The illumination means comprises a diode area with a plurality of light emitting diodes (LEDs) arranged to emit light out of the first open end and through the transparent area of the releasably locked head. The heat generated when the LEDs are activated is removed from the diode area using a heat sink, which comprises a central part of a first material, and at least one peripheral part of a second material, and said first material is different from said second material. Furthermore, the torch comprises a power source comprising a battery holder and switches for activating the power source and thereby the torch. The functionality of the torch is controlled by a first microprocessor which preferably is located in the inner torch assembly. The first microprocessor comprises means for storing program settings and data received from an external source, for example through a second microprocessor. A second microprocessor may comprise communicative means for communicating with both said first microprocessor and at least one external control unit, which is used for programming the functionality of the torch. Furthermore, the torch may be equipped with a removable cover encasing at least the transparent area of the releasably locked head. This cover provides means for arranging optical means for adjusting the optical properties of a lightbeam emitted out through the transparent area the releasably locked head.

### Customization

As described above, due to the first microprocessor being externally accessible, it is possible to customize the functionality of the torch by the user or producer or any other party capable of communicating with the microprocessor. In the present context the term “microprocessor” is used synonymously with the term “microprocessor” in the meaning of a means capable of being programmable and capable of controlling one or more functions of the torch and optional units connected to the torch. By the term externally accessible is meant that the microprocessor, directly or indirectly as described herein, may be programmed using a computer which is external to the torch, such as a conventional PC having a program installed capable of customizing the torch.

A variety of settings of the torch may be programmable, such as frequency of flashlight strobe, button functions, special functions, modes (for example using preset modes), and drive (for example ECO drive vs. MAX drive). In the following is a list of examples of programmable embodiments:
Normal
Define optimal drive for light vs. max power vs. eco-drive
Morse
Define on/off time
Define how smooth light is turned on.
Define strobe frequency
Define max current
Define power levels (function)
Define how to dim (with constant press, or with several presses)
Switch lock function On/Off
Strobe by magnet on/Off
Instant strobe (AttackMode)
Constant Strobe by press, hold, (strobe), release
Battery warning set time (ex. 1 hour)
Max temperature
More temperature levels.
Diving mode
Time (“Real-time Clock”)
Turn flashlight On/Off at given time using “Real-Time Clock”
Switch back to normal state using a series of button commands.
Special IR, UV, Laser modes
Blitz Photography—externally triggered
With vibrator so that when rf message/signal is received it vibrates.
Save previous settings

As stated herein the first microprocessor may be accessed directly from an external computer or other means, either through a wired link or wireless. However, the first microprocessor may also be programmed through an initial programming of a second microprocessor which then subsequently forward relevant instructions to the first microprocessor.

### Connectable Units

Furthermore, the programming of a first and/or a second microprocessor may also include programming of a unit or a device connected to the torch. As described below the invention may also include a detachable unit that is attached to the torch, such as attached to the rear (ie. second) end of the torch, for example interfacing with the torch through a communication interface, such as an IrDA interface. The units can accommodate functions, such as
Infrared beacon
Laser unit
Sensor w. Alarmsound
GPS
RF slave/master function
Act as a control unit also receives signals from other flashlights.
Pressure PAD with analog clicks for diff. button states.
Camera unit (also with memory so no RF is needed)
Sound recording unit (Surveillance unit)
Vibrator
Accelerometer
Pressure sensor w. memory

The units can be stacked, so several functions can be accessed at the same time. The units may also communicate or simply receive instructions from one or more externally arranged units, such as an external computer. For example a GPS together with a RF can send the position of the flashlight to a central unit, and subsequently the central unit may forward instructions to the first microprocessor as described above. Furthermore, the unit(s) may also be programmed or receive instructions from the first and/or the second microprocessor.

### Programmable First Microprocessor

The functionality of the torch is preferably controlled by a first microprocessor positioned inside the case. The first microprocessor is programmable and its program settings can be changed by the user himself thereby making it possible for the user to customize the functionality of the torch according to the situation wherein he will be using the torch.

In one embodiment, the first microprocessor and/or the torch provides means for direct communication with said at least one external control unit. This may be through wireless communication techniques, such as a Bluetooth connection, radio signals, WiFi, Infrared communication, or any other technology suitable for wireless communication between two units. Alternatively, the direct communication between the first microprocessor and the at least one external control unit utilizes techniques for wired communication such as a suitable console, parallel cables, serial cables, USB cables, or any other cable suitable for communication between two units. In a preferred embodiment, the second cap and/or the case can provide means for establishing the connection from the first microprocessor to the external control unit.

In one embodiment the second cap and/or the case provide means for directly connecting the first microprocessor to the external control unit.

### Programming Through A Second Microprocessor

In a preferred embodiment, the torch comprises in addition to said first microprocessor at least one additional microprocessor, such as a second microprocessor, wherein said at least one additional microprocessor provides means for establishing a communication link between said first microprocessor and said at least one external control unit. The at least one additional microprocessor comprises means for communicating with said first microprocessor and means for communicating with said at least one external control unit. In the following text, the communication link between the first microprocessor and the at least one external control unit according to the present invention is exemplified with a first microprocessor and a second microprocessor, but other embodiments utilizing several additional microprocessors are also within the scope of this invention.

In one embodiment, the means for communicating between the first microprocessor and said second microprocessor comprise means for wired communication techniques such as a wire and/or a cable or any other suitable means for wired communication between two units. Alternatively or in addition to the means for wired communication, the first microprocessor and the second may comprise means for wireless communication such as a Bluetooth connection, radio signals, WiFi, Infrared communication, or any other technology suitable for wireless communication between two units.

In a preferred embodiment, the communication link between the second microprocessor and said at least one external control unit, comprise means for wired communication using a cable and/or wire suitable for wired communication between two units and/or means for wireless communication such as a Bluetooth connection, radio signals, WiFi, Infrared communication, or any other technology suitable for wireless communication between two units.

The means for establishing a wireless link between the first microprocessor and the second microprocessor as well as the the means for establishing a wireless link between the second microprocessor and said at least one external control unit comprise components such as transmitters and receivers. These may be integrated on the microprocessors or located off the microprocessors.

In a preferred embodiment, the second microprocessor is located in the releasably locked head which comprises means for connecting to a suitable console. The console is preferably equipped with means for connecting to the at least one external control unit and/or equipped with means for transferring data and program information to the second microprocessor. The external control unit preferably comprises an interactive tool such as a personal computer

Alternatively, the means for wired communication between the second microprocessor and the at least one external control unit may comprise means in said second cap and/or means on said case wherein an appropriate connector with suitable watertight cap can be positioned.

Preferably, the first microprocessor and/or said second microprocessor comprise a non-volatile memory such as an EPROM or an EEPROM.

In a preferred embodiment, said first microprocessor and said second microprocessor comprise means for communicating when the torch is turned on, thereby providing means for transferring the data and program instructions stored in said second microprocessor to said first microprocessor. Thereby the functionality of said first microprocessor can be customized to any given situation.

### Light Effect

In general, the torch can be equipped with various kinds of light emitting units (LUV) such as small incandescent light bulbs or light emitting diodes (LEDs). The at least one light emitting unit (LEU) is arranged to emit light out of the first open end and through the transparent area of the first cap or said releasably locked head covering the first end of the case. In a preferred embodiment the torch is equipped with at least one light emitting diode (LED).

One important aspect of the present invention is a portable torch providing a powerful light effect, such as as effect of at least 100 lumen, more preferably at least 200 lumen, more preferably at least 300 lumen, more preferably at least 400 lumen, more preferably at least 500 lumen, more preferably at least 600 lumen, more preferably at least 700 lumen, more preferably at least 800 lumen, more preferably at least 1000 lumen, more preferably at least 1200 lumen.

The powerful effect is obtained because the present invention takes advantage of light emitting diodes (LEDs) in the visible spectrum and/or in the infra-red (IR) spectrum and/or in the ultra-violet (UV) spectrum arranged in a configuration providing the light effect effectively.

A light emitting diode (LED) is a compact semiconductor device that generates light of various colors when a current is passed through it. The color depends primarily upon the chemical composition of the light emitting components of the LED die. LEDs exhibit various advantages over incandescent, fluorescent, and discharge light sources, including smaller size, longer life, lower power requirements, good initial drive characteristics, high resistance to vibration and high tolerance to repeated power switching. Because of these favorable characteristics LEDs are widely used in such applications as indicators and low-power lighting applications.

Although LEDs are more efficient than prior art light sources, they are not 100% efficient in converting electrical energy to light. As a result, a great deal of heat can be produced by the LED die. If the heat is not adequately dissipated, mechanical stress is imposed on various internal components of the LED due to the differing coefficients of thermal expansion of the internal components. This stress can lead to failure of the LED. Therefore, heat sinks are often employed to dissipate heat generated by the LED. The heat sink is usually provided through the metal lead frame of the LED.

The amount of heat generated by the LED becomes an even greater concern as higher-power LEDs are developed for high-brightness applications. The heat accumulation has previously been a limiting factor for increasing the number of LEDs in a portable illumination means, because LEDs has to be arranged sufficiently far from each other to secure that the heat produced by one LED does not disturb the function of a neighbour LED, which is especially true if an LED is surrounded by other LEDs. On the other hand the size of a portable torch cannot increase beyond a certain limit, otherwise the portability of the torch is lost.

As disclosed in patent application WO 2007/028397, it is possible to increase the number of LEDs without tampering the function of individual LEDs, such as reducing the life time of the LEDs, and at the same time provide a compact portable torch. This is due to the fact that the portable torch according to the invention of WO 2007/028397 and according to a preferred embodiment of the present invention comprises a heat sink arranged to transport heat from the LEDs. Thereby LEDs may be arranged closer to each other than what is the case if no heat sink is present, and accordingly, more LEDs may be arranged in the portable torch leading to a higher light effect.

The LEDs are preferably designed to be assembled onto a printed circuit board and secured using soldering process. In the present context the term “diode area” includes the printed circuit as well as the space between the diodes. In the invention according to WO 2007/028397 and in a preferred embodiment of the present invention a plurality of LEDs are preferably mounted on the printed circuit by a solder connection to the legs of the LEDs in the usual manner in the art. Thereby the LEDs extend from the lower surface of the printed circuit.

In one embodiment it is preferred that the portable torch comprises at least 3 LEDs, more preferably the portable torch comprises at least 5 LEDs, such as at least 7 LEDs. The LEDs may be arranged in any suitable pattern in the portable torch. When the torch comprises more than three LEDs, it is however preferred that the LEDs are arranged with at least one central LED surrounded by a number of LEDs.

Independent of the pattern it is preferred that the heat sink is arranged to remove heat from the central part of the LED area. In particular if the LEDs are arranged in a circular pattern it is preferred to remove heat from the central part of the LED area.

The LEDs may be any suitable types of LEDs, such as LEDs of various shapes, colors, and/or viewing angles. In some embodiments, white LEDs are used (such as white LEDs that utilize a blue LED chip and a YAG phosphor that converts a portion of the blue light to yellow, thus yielding a white-appearing light output. In other embodiments, standard high-efficiency colored LEDs of red, yellow, green, and/or blue are used to provide light of the desired intensity and color. In one such embodiment, LEDs of each color are preferably controlled separately in order to provide the desired overall hue or whiteness of the combined light output.

Other embodiments include IR LEDs for military or police use to enhance the usefulness of night-vision equipment and for friend-or-foe identification. Other specialized uses may be long-wavelength LEDs, 660 nm or longer to provide underwater divers a light source for observing undersea life at night without adversely affecting the nocturnal activities of such wildlife.

In order to provide the powerful light effect desired by the present invention the effect of each LED is preferably at least 2 W, more preferably at least 3 W, more preferably at least 4 W, more preferably at least 5 W, more preferably at least 6 W.

In a preferred embodiment the LEDs are selected from LEDs from Luxeon Emitter or Osram Ostar. Each LED preferably provides at least 30 lumen, more preferably at least 40 lumen.

In a preferred embodiment the portable torch provides at least 5 LEDs within a diameter of 54 mm, such as at least 7 LEDs within a diameter of 54 mm. In another embodiment the portable torch is provided with at least 2 LEDs within a diameter of 40 mm, such as at least 3 LEDs within a diameter of 40 mm. Thereby the distance between the center of one LED to the center of a neighbouring LED is at most 2.1 cm, such as at most 1.8 cm.

### Lenses

A preferred feature of some of the aspects of the present invention is to provide a large number of LEDs per square unit in order to provide a sufficient generalized and/or focused illumination. Therefore, an embodiment of the invention utilizes a lens or a reflector arrangement to provide a focusable light source. Thus, in one embodiment of the invention the portable torch light is provided with means for controlling the “viewing” angle of the LEDs in order to achieve wide-angle viewing versus narrow-angle, long-range viewing and combinations thereof.

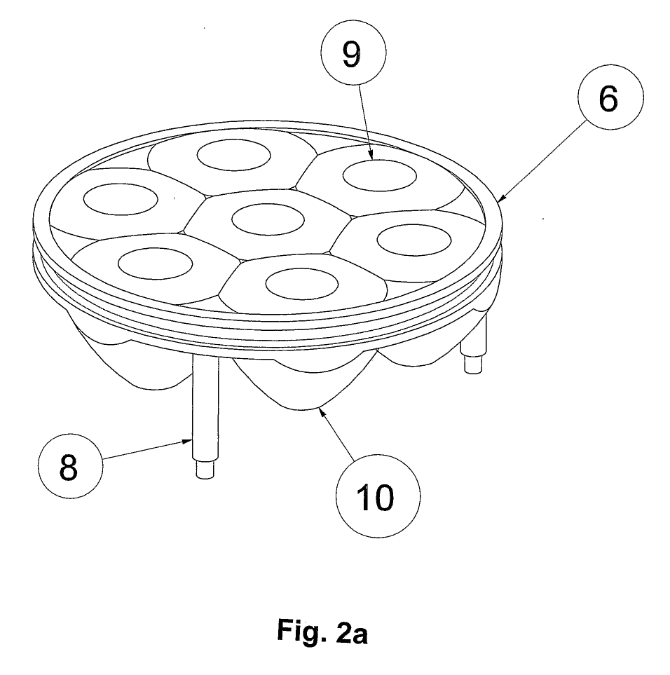

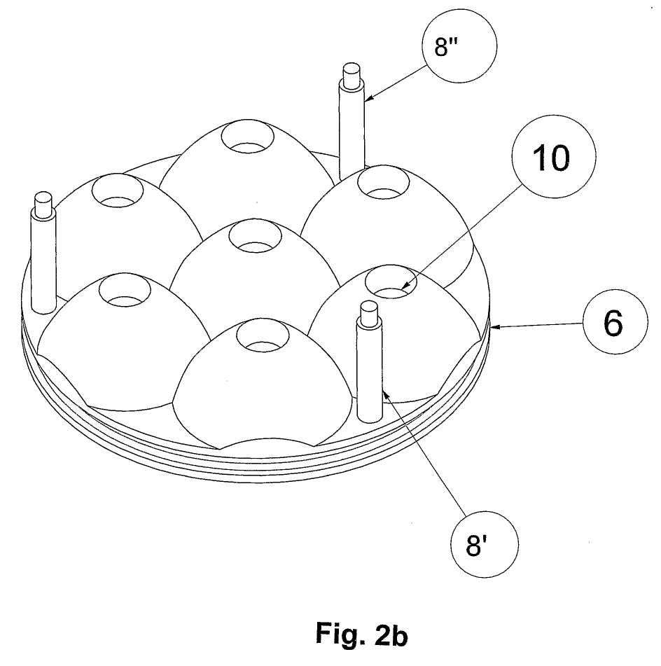

An example thereof is a portable torch wherein a lens is provided in the light path of at least one LED, preferably wherein a lens is provided in the light path of all LEDs. Thereby the viewing angle may be controlled. The lens may be one lens generalizing or focusing the light from all LEDs or in a more preferred embodiment a lens is arranged for each LED. The lens(es) is(are) preferably integrated with the transparent area of the first cap or the releasably locked head. In a preferred embodiment hereof the lenses are arranged in recessed parts of the transparent area, as explained for example in relation to FIG. 2, whereby the risk of damaging the lenses, such as damaging by scratching is reduced.

The lenses may be of any suitable type, such as Fresnel lenses or mirror coated lenses, such as coated with metal or metal alloys.

Examples of preferred configurations of viewing angles are the following:
A portable torch wherein the optical axis of a first LED and the optical axis of a second LED are parallel. Thereby neither convergence nor divergence of light from two or more LEDs occur.
A portable torch, wherein lenses are arranged so that light from at least two LEDs converge, such as to provide a central focused light path.
A portable torch, wherein lenses are arranged so that light from at least two LEDs diverge, such as to provide a defocused light.

### Heat Sink

As described above the present invention provides a portable torch capable of arranging a large amount of LEDs on a small area without impairing the function of the LEDs. This is due to a heat sink arranged to remove heat from the LEDs, in particular from a central LED. The heat sink arrangement can also be utilized in relation to other LEUs.

Thus, in the present context the term “heat sink” or “heat dissipating means” refer to means for transporting heat away from the diodes, in particular from a central diode, so that the temperature around the diodes does not exceed a level above which the function and lifetime of the diodes are unacceptably reduced.

In a preferred embodiment the heat sink comprises a core of heat sink material, such as metal, such as selected from the group of material consisting of Aluminium, Copper, Silver, Platinum, and Gold. The heat sink may be constructed in any suitable way taking into account that the heat sink should have as large a surface area as possible on one hand, and on the other hand should still be of a handy size. In one embodiment the heat sink is provided with a plurality of axially extending ribs to increase the surface area. By the term “axially” is meant parallel with an axis extending from the first end to the second end of the torch. In a preferred embodiment, the number of axially extending ribs is in the range 1 to 30, such as in the range 5 to 25, such as in the range 10 to 20, such as in the range 12 to 18, such as 15.

The heat sink may be in one part or may be constructed of several parts, such as being constructed of at least two parts. When the heat sink is constructed of more than one part the individual parts are connected by means of thermally conducting material.

In one embodiment the heat sink comprises a central part of a first material and at least one peripheral part of a second material. It is preferred that the first material has a higher heat conductivity than the second material whereby the heat is transferred rapidly from the diode area. Heat conductivity is used in its conventional meaning, i.e. the quantity of heat transmitted through a unit thickness. Heat conductivity may also be denoted heat transfer coefficients.

The second material may preferably have a higher heat capacity than the first material so that the second material is capable of “storing” more energy before the temperature of the second material is raised. Heat capacity is used in it's conventional meaning, i.e. the measure of the, quantity of energy needed to raise the temperature of a unit quantity of the material through 1 degree of temperature.

In a preferred embodiment the first material is selected from copper, gold or silver or a metal or an alloy having having a heat capacity and/or a heat conductivity as one of those metals. The second material is preferably selected from aluminium or a metal or alloy having a heat capacity and/or a heat conductivity as aluminium. Preferably, the peripheral part is arranged with a plurality of radially extending parts as described above.

The height of the heat sink, wherein height is the dimension in the axial direction, is preferably at least 1.0 cm, more preferably at least 1.5 cm, more preferably at least 2.0 cm, in order to provide a sufficient surface area. Furthermore, it is preferred that the width of the heat sink corresponds to the width of the inner case so that the heat sink with ribs extends to the inner case wall.

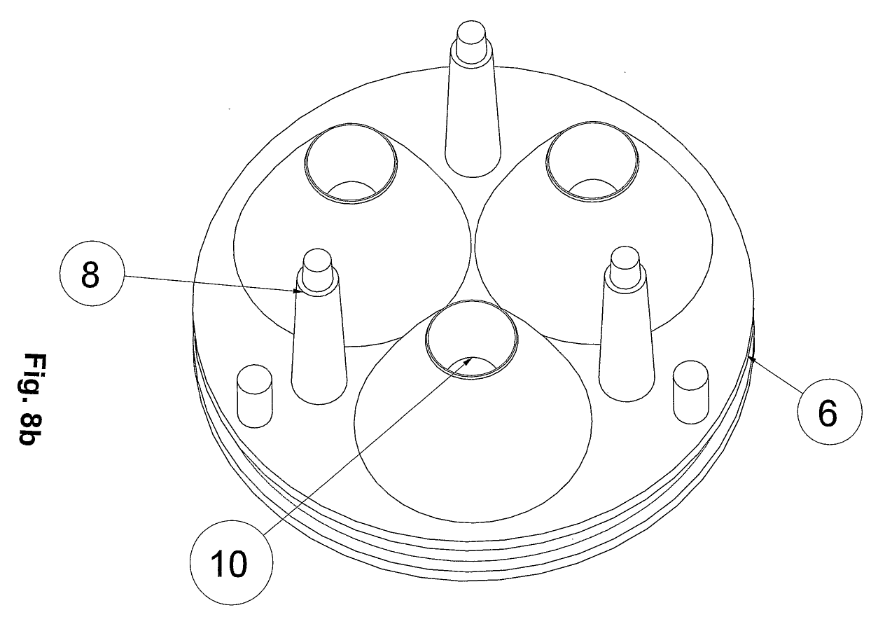

The heat sink is preferably constructed so that is provides a bearing surface for each LED. Examples of configurations of the heat sinks are shown in FIG. 13.

In a preferred embodiment the heat sink is thermally connected to a rod extending from the printed circuit, and thereby the diode area, and at least to the heat sink. The rod is preferably arranged axially, and more preferably centrally in the torch. Thereby the rod may also function to fix the printed circuit in relation to the inner torch assembly. The rod extends from the diode(s) and through the part of the case housing the battery(ies), whereby the heat is transported away from the diode area and also distributed in the case. The rod is preferably arranged as the central part as described above, and consequently the rod is preferably made from copper, or a metal or an alloy having a heat capacity and/or a heat conductivity as copper, such as gold or silver.

In order to save space in the case, the heat sink rod may constitute at least a part of the battery holder, such as the embodiment wherein the battery holder comprises at least two pins connected to a central pin, said central pin being the heat sink rod.

In one embodiment the heat sink system is based on a copper rod connecting one or more aluminium heat sinks, and the torch comprises 7 LEDs as described above. The copper rod has a large heat capacity (cp) per volume and also a good heat transfer to the outer area. This system can absorb the heat at maximum power for some minutes. As described in more detail below, the driver and controlling circuit include a temperature sensor, so when maximum allowed temperature is reached a dimming function will reduce the current in the LED's.

In the following an example of heat transfer calculations is described for a heat sink comprising a central copper rod connected to aluminium heat sinks. In the example the following approximations have been done
the cooling elements are regarded as one element
power transfer to the battery back is disregarded
heat convection to ambient is disregarded

Under these conditions maximum temperature rise for a given time can be calculated:
Heat capacity=Specific heat*Weight
Copper specific heat=385 J/(kg*° C.)
Aluminum specific heat=896 J/(kg*° C.)
Copper Weight=0,022 kg
Aluminum Weight =0,111 kg
Whereby the Heat Capacity for the system is=896*0.111+385*0.022=108 J/° C.
Maximum dissipated heat from LED system=1.4 A*7*3.5V*0.9=31 W
And Temperature rise per second=31/108=0.28° C./s

Since no heat dissipation to ambient is deducted then this is maximum temperature rise. In a preferred embodiment the torch electronic will measure temperature and decrease current when temperature exceeds 55° C. Given time constants in the system this equates a heat sink temperature of approximately 60 to 65° C. For each 20 seconds, the current level will then be decreased one step as long as temperature is measured above 55° C. The torch has preferably several light levels defined, such as preferably at least 10 light levels, more preferred at least 15 light levels, such as 18-20 light levels.

Now given an ambient temperature of 20° C. and the fact that dissipated power will start decreasing at 60° C. it will take a minimum 40/0.28=142 seconds before light level will start decreasing.

### Case

The portable torch according to the invention comprises a case, said case having any convenient size and shape, and is typically designed to hold the battery, provide a suitable grip to be handheld, and provide a housing for the inner torch assembly, such as battery, circuitry, heat sink and light emitting units (LEUs). The case has a first end that is open and a second end that may be open or closed. When the second end is open the torch may be mounted through this during assembling. The case is preferably provided with a first cap or a releasably locked head covering the first end. When the second end of the case is open, a second cap covers the second end. Said first cap or releasably locked head has a transparent area through which the light from the LEUs pass. Said first cap or said releasably locked head preferably comprises in said transparent area the lenses discussed above. The first cap may be attached to the case through any suitable means, such as releasably attached for example through threads, lock rings or splits.

Preferably, the outer part of the first cap or the releasably locked head is fabricated in a material with a low thermal conductivity to ensure that its outer parts maintain a temperature that is comfortable for the user.

The second cap may be provided with means for connecting another battery-driven device. Thereby the torch may be capable of functioning as a battery-tank for another battery-driven device. Furthermore, the second cap may comprise means for connecting the portable torch to a recharging unit for recharging the batteries.

In a preferred embodiment the portable torch is water-proof and/or gas-proof, whereby the connections from case to caps and releasably locked head are sealed, for example by means of O-rings suitably arranged. Likewise are any other penetrations of the case, such as switches, sealed, for example by means of O-rings or the like.

The case may be made from any suitable material, such as machined from a metal, such as a metal selected from Aluminium and Titanium. The case may be black or titanium anodized to obtain a finish, and/or the case may be coated at least partly with a suitable material to improve the grip of the torch, such as an elastomeric material.

In another embodiment the case is connected to the first cap through a flexible cable, whereby the (heavy) case may be carried by the user for example fixed to the body of the user and only the first (lighter) cap is held by hand, see for example FIG. 17. Thereby the use of the torch is facilitated.

### Releasably Locked Head

In a preferred embodiment, the first end of the case is covered with a releasable locked head. The releasable locked head may comprise a second microprocessor used for communication with the first microprocessor and for communication with the external control units. Furthermore, the releasable locked head may comprise at least one lens arranged in the light path from the light emitting units located in the inner assembly of the case.

In the embodiments of the present invention, wherein the communication between the first microprocessor and the second microprocessor utilizes a wirebased technology, the internal assembly of the torch provides means for establishing an electrical connection between the first microprocessor and an interface which is brought into contact with an interface on the releasably locked head. The releasably locked head furthermore provides means for establishing an electrical connection between the second microprocessor and said interface. This electrical connection from the interfaces to the microprocessors can for instance be established by using conductive wires or conducting tracks on printed circuit boards.

Preferably, the releasable locked head comprise means for mounting it in a console equipped with means for connecting the second microprocessor located inside the releasable locked head to the external control unit. Alternatively, the console itself provides means for customizing the functionality of the torch, such as means for entering the programming commands and settings.

In order to prevent any excessive twisting of any wires used in relation to the communication between the first microprocessor and the second microprocessor, the releasably locked head comprises rotation preventing means that essentially prevents rotation of the releasably locked head relative to the case around the longitudinal axis of the case when the releasably locked head is locked onto or released from said case. The rotation preventing means in the releasably locked head have inter-related counterparts in the case and/or the inner torch assembly. In a preferred embodiment, the rotation preventing means of the releasable locked head comprise at least one hole extending parallel to the longitudinal axis of the case. At least one solid rod anchored in the inner torch assembly and extending parallel to along the longitudinal axis of the case can be inserted in said at least one hole, wherein the diameter of said at least one hole essentially is identical to the diameter of said at least one rod. In another embodiment at least two engaging means, each having a recess, engage a protrusion on the case. Preferably, the rotation of the releasably locked head around the longitudinal axis of the case is below 10°, preferably below 5°, more preferably below 2°, even more preferably below 1°.

In a preferred embodiment, the releasably locked head comprises a front ring, a turn ring, and a middle ring, wherein said turn ring comprise means for attaching said rods to the ring.

Preferably, the outer part of the releasably locked head is fabricated in a material with a low thermal conductivity to ensure that its outer parts maintain a temperature that is comfortable for the user.

### Cover With Optics

The torch can furthermore be equipped with a removable cover encasing at least the transparent area of the first cap or the releasably locked head. The cover provides means for arranging optical components in the beam path thereby making it possible to change the optical properties of a light beam emitted out through the torch. The light beam can be focused by a single converging lens or a suitable combination of optical elements which in combination converges the light beam. Alternatively, the light beam can be diverged by a single diverging lens or a suitable combination of optical elements which in combination diverges the light beam. Other optical elements, which can be applied to alter the optical properties of the light beam are optical elements for reducing the intensity of the beam and/or filters for changing the hue or colour and/or the temperature of the beam and/or optical element for diffusing the beam. The optical element for diffusing the light beam can be a material with a high optical depth and very short mean free path. Furthermore, the cover can provide protection for the transparent area of the first cap or the releasably locked head.

### Second Battery-Driven Device

In a preferred embodiment second cap of the case of the portable torch according to the invention has means for connecting a second battery-driven device to the battery of the portable torch, such as the connectable units described above. In a preferred embodiment, the means is arranged in the second cap. The second battery-driven device may be any kind of battery-driven device often used in connection with a portable torch. Accordingly, the second battery-driven device may be a light directly attached to the second end portable torch, or alternatively the second battery-driven device is connected through a line to the second end of the portable torch, whereby the second light may be born separate from the first light, for example in the cap of the user. In yet another embodiment a cap comprising a diode area of the second battery-driven device is connectable to the portable torch.

The second light may also serve other purposes than the first light. For example the second light may be infrared or ultraviolet, whereas the first light is white light, or the second light may be a flashing light. In another embodiment the second light may be coloured for friend-or-foe identification. Other examples of the second battery-driven device are a laser, a radio, a mobile telephone, sensors, recording equipment, such as audio or video equipment.

In one embodiment the second battery-driven device is a second torch or light, also called a taillight. The illumination means of the taillight is preferably an LED, such as the LEDs described above. In a preferred embodiment the LED of the taillight is an LED provided by OSRAM Ostar), such as an LED providing at least 200 lumen per diode. In a more preferred embodiment the tail-light is provided with a heat sink independent from the heat sink of the first illumination means.

In another embodiment the second battery-driven device is a second torch or light carried independent from the portable torch, only being connected to the portable torch during recharging of the second torch. The illumination means of the taillight is preferably at least one LED, such as the LEDs described above. In a preferred embodiment the LED of the second torch is an LED provided by OSRAM Oster), such as an LED providing at least 200 lumen per diode. In a more preferred embodiment the second torch is provided with a heat sink independent from the heat sink of the portable torch. In a preferred embodiment the second torch comprises a case having any convenient size and shape, and is typically designed to hold the battery, provide a suitable grip to be handheld, and provide a housing for the inner torch assembly, such as battery, circuitry, heat sink and LEDs, wherein the case has a first open end and a closed second end, so that the torch may be mounted during assembling through said first open end. The case is preferably provided with a cap covering the first end, wherein said cap has a transparent area through which the light from the diodes pass. Said cap may comprise in said transparent area the lenses discussed above. The cap may be releasably attached to the case through any suitable means, such as releasably attached for example through threads, lock rings or splits. The open end is provided with means for connecting the portable torch for recharging the batteries of the second torch, so that when recharging is necessary, then the cap is removed from the second torch, and the second torch is connected to the second end of the portable torch for recharging the second torch.

As described in relation to the portable torch, any second battery-driven device may be water-proof and/or gas-proof, whereby the connections from case to caps are sealed, for example by means of O-rings suitably arranged. Likewise are any other penetrations of the case, such as switches, sealed, for example by means of O-rings or the like.

The case of any second battery-driven device may be made from any suitable material, such as machined from a metal, such as a metal selected from Aluminium and Titanium. The case may be black or titanium anodized to obtain a finish, and/or the case may be coated at least partly with a suitable material to improve the grip of the torch, such as an elastomeric material.

Switches for said second battery-driven device may be arranged at any suitable position of the torch, it is however preferred when the second battery-driven device has a closed end opposite the diode(s) that the switch(es) is(are) arranged in the closed end.

Furthermore, a magnet may be positioned on or in the case of a second battery-driven device, such as positioned in the closed end.

### Battery And Portable Power Source

The power source of the portable torch of the present invention is preferably rechargeable batteries housed in the case. The batteries serve to provide power to the units emitting light through the transparent area of the first cap. In addition thereto the batteries may provide energy to another battery-driven device, such as another light connected to the second cap. Thereby the portable torch serves as portable power source for a second battery-driven device. Furthermore, the battery (batteries) may drive any computer arranged to control the torch function.

Any suitable rechargeable battery may used, such as a battery pack available from a line or series of battery packs having different predetermined operating voltages that fall within the range from 1.2V to 24.0V DC. Apart from the difference in operating voltage, all battery packs of the same line have substantially the same physical shape and size, at least insofar as their stems (for internal connection) and the upper peripheries of their bodies (for external matching) are concerned, such that any one of the battery packs can fit the torch light.

In a preferred embodiment, wherein the portable torch also serves as a portable power source as described above, it is preferred that the battery can supply at least 12 volt 2 Amp, i.e. 24 VA, more preferably about 12 Volt 4 Amp, i.e. 48 VA, wherein VA means Volt Ampere.

The portable torch may be provided with an alarm function when the battery level is low. Such an alarm function may be a sound or a stroboscopic light effect.

The battery is preferably recharged while remaining in its position in the case. In a preferred embodiment the battery is recharged through a connection in the second end. In a more preferred embodiment the connection for connecting a second battery-driven device is identical with the connection for connecting to a recharging unit.

Preferably, the battery pack is to be inserted downwards into the case of the torch as part of the inner torch assembly, for locating thereby. In doing so, the battery stem preferably extends to the inner case wall.

### Switches And Circuitry

The inner torch assembly is in a preferred embodiment arranged to contain a rechargeable battery, and at least one light emitting unit (LEU) preferably in the form of an LED, connected to at least one switch. Furthermore, that battery is connected to an electrical input terminal for supplying electrical power to the rechargeable battery. The battery, the LEU (s) and the electrical input terminal are electrically coupled via a circuit mounted on a printed circuit board.

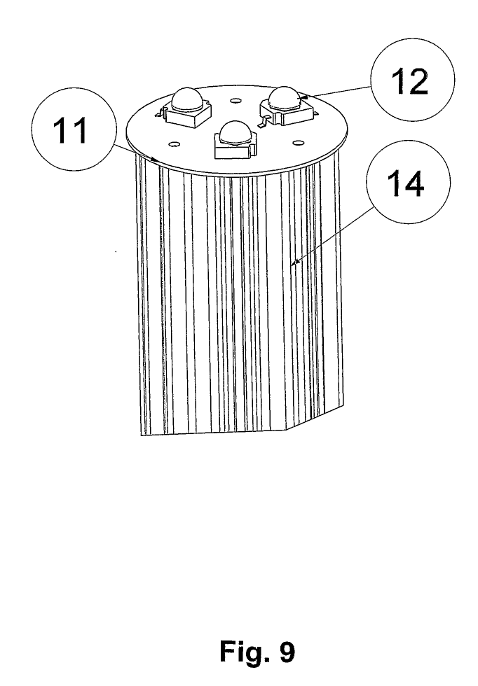

The application of the electrical energy to the LEUs is controlled by means of a switch arrangement, which is attached to the case at any suitable place, such as on the side of the torch or in the second end or in the cap covering the second end. Any appropriate technique may be used for securing the switch arrangement to the case. A preferred arrangement is shown in FIG. 14. The switch arrangement may include a number of switches for controlling various functions of the portable torch, it is however preferred that the portable torch comprises only two switches in order to simplify the use of the portable torch. The switches are normally programmed to perform a variety of parameters thereby allowing the user to control various flashlight functions such as, for example, on/off, setting light level, setting light color, setting pulse or strobe frequency, and checking battery voltage or remaining power. For example one switch may turn on light, and the other turn off light. Increasing/decreasing the light output may be done by keeping one switch down until the desired light output is reached. The portable torch could furthermore be programmed so that activation of one or both switches in preprogrammed steps could provide stroboscopic light effect or any other relevant light effect, such as an SOS-signal. Furthermore, the switch arrangement is preferably also programmed to activate any second battery-driven device coupled to the second end of the portable torch. In a preferred embodiment it is possible to control the illumination of the torch and the second battery-driven device independently.

In another embodiment only one switch is provided for on/off as well as for other programs whereby the frequency of activation of the switch may activate different functions.

In one embodiment the switch arrangement is programmed to receive a feedback signal from a feedback circuit, and on the basis of the feedback signal adjust for example the light output to prevent overloading and premature destruction of LEDs while minimizing power dissipation, thus maximizing battery life, providing the desired accuracy or level of the amount of light emitted at different battery voltages or other environmental conditions that would otherwise vary the light output. In particular the feedback signal could be triggered if the temperature in the diode area exceeds an acceptable level. In such an embodiment it is preferred that a temperature measurement means is arranged for example on the printed circuit board.

Furthermore, in a preferred embodiment the switch arrangement is programmed to provide a relatively constant light output level even as battery voltage declines and power is drained.

The portable torch may be preprogrammed with functions and/or the programs of the portable torch may be customised.

It is preferred that the first microprocessor is utilized to provide control functionality of the switches. However, a variance of this embodiment uses a thumb-wheel, or rotary switch to vary the switching characteristics to produce a variable light output.

A magnet may be arranged adjacent to the switch arrangement for attachment.

When the torch is attached to a surface, the switches are preferably activated due to pressure from the surface. The constant pressure from the surface may lead to a special illumination, for example a stroboscopic light for use in case of accidents.

The switches may also function as pressure valves to reduce pressure in the torch body. An example hereof is shown in FIG. 14.

### Water- And/Or Gas-Proof Torch

In a preferred embodiment, the releasably locked head or the first cap sealingly covers the first open end. In embodiments wherein the second end is open, the second open end is preferable sealingly covered by the second cap. Preferably, the means for activating the power source operatively associated with said case comprises one or more switch buttons sealingly arranged on the case. Preferably, all openings on the torch are water- and/or gas-tight and the torch is water-proof and/or gas-proof. Preferably, the torch is water-proof and/or gas-proof to at least a pressure difference of 10 bars, thereby allowing divers to use the torch.

### Modular Kit

In one aspect the present invention relates to a modular kit comprising two or more modules, wherein a portable torch as defined herein is one module and another module(s) is one or more second battery-driven devices, wherein the each of said second battery-driven devices and/or a cap comprising a diode area of said second battery-driven device are connectable to the portable torch as described above.

### DETAILED DESCRIPTION OF THE DRAWINGS

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention.

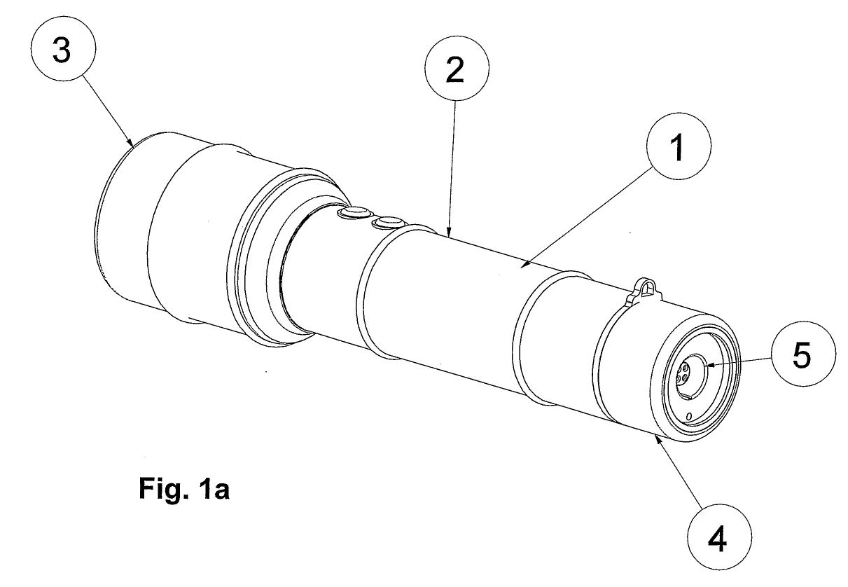

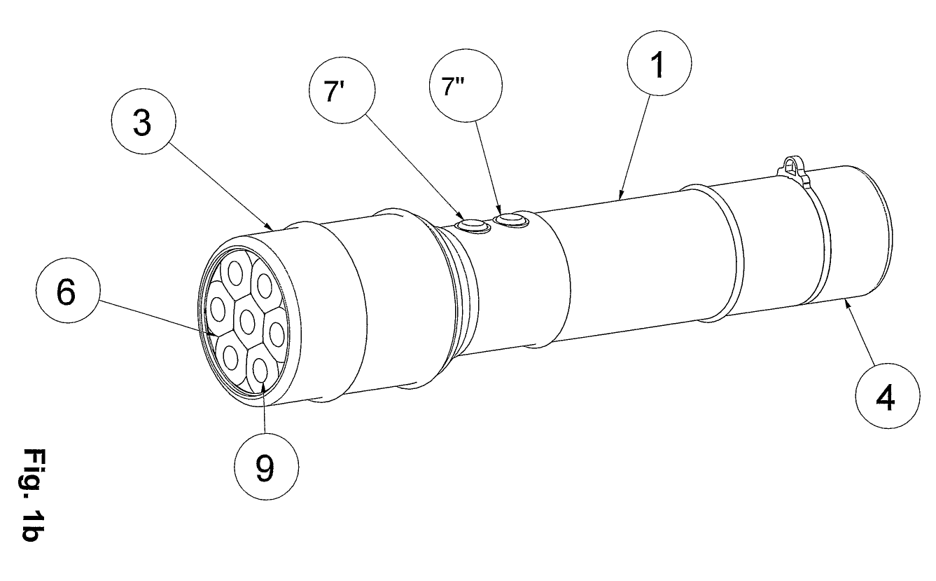

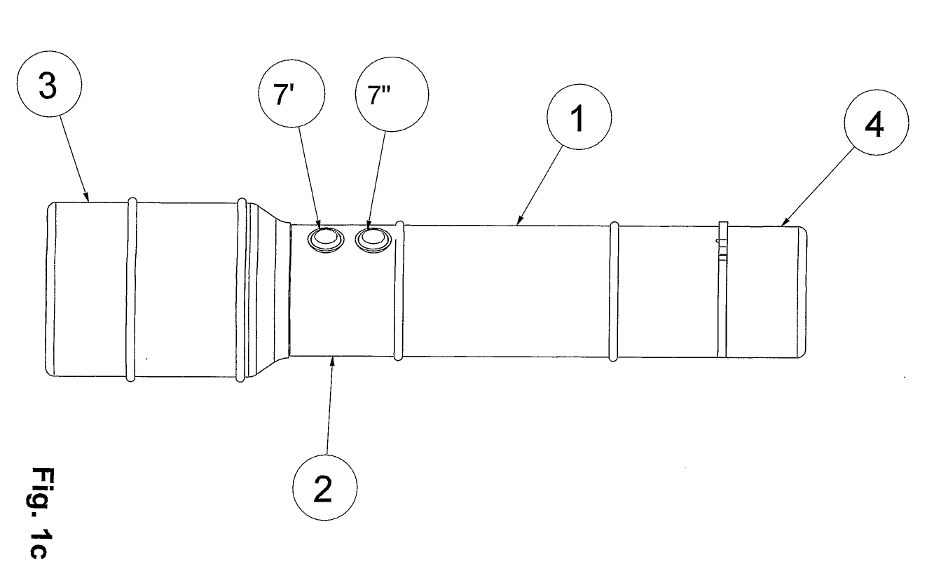

FIG. 1a shows the portable torch 1 according to the invention seen from the second end of the torch. The torch 1 has a case 2 and a first end being closed with a first cap 3 and a second end being closed with a second cap 4. The second cap 4 is provided with connection means 5 for connecting a second battery-driven device to the portable torch 1, whereby the portable torch 1 serves as a battery-tank for the second battery-driven device. FIG. 1b shows the portable torch 1 seen from the first end of the torch. Thereby the transparent area 6 of the first cap 3 is shown. The transparent area 6 comprises seven recesses corresponding to seven diodes. In each recess a lens is located (not shown). The portable torch 1 further provides two switches 7′, 7″ for controlling the function of the portable torch 1. In FIG. 1c the portable torch 1 is seen from the side showing the first cap 3, the second cap 4 as well as the switches 7′, 7″.

FIG. 2a shows the outer surface of transparent area 6 of the first cap. The transparent area 6 is provided with seven recesses 9, a recess 9 for each diode of the portable torch. In the bottom of the recess 9 a lens 10 is provided. By arranging the lens 10 in a bottom of a recess 9, the risk for scratches on the lens 10 is minimized. The transparent area 6 is positioned to a diode area (not shown) below the transparent area 6 by means of fastening rods 8. FIG. 2b shows the inner surface of the transparent area 6 of FIG. 2a. The lens 10 is shown positioned in the bottom of the recesses. Three fastening rods 8 are provided for positioning the transparent area 6.

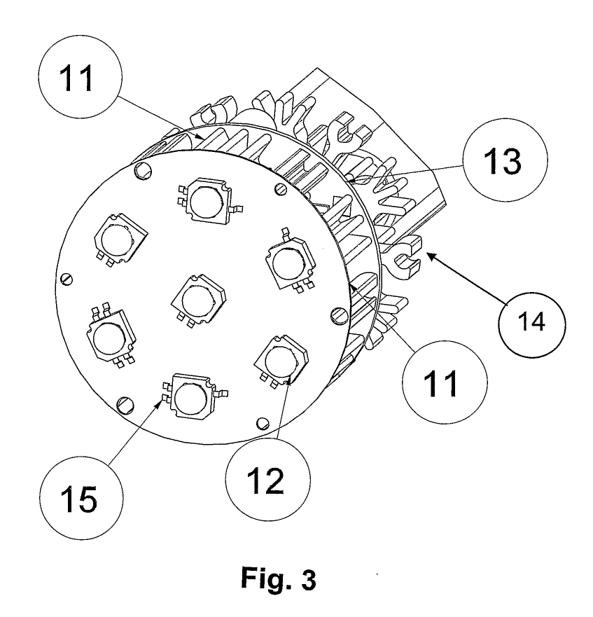

FIG. 3 shows a diode area 11 having seven diode positions 12 for positioning diodes. Diodes are provided with power from the power source through circuit 13. A heat sink 14 is positioned below the diode area 11.

FIG. 4 shows the heat sink 14 of the portable torch in greater detail. The heat sink is constituted of two parts, 14′ and 14″. The heat sink part 14′ is located immediately below the diode area 11. The heat sink 14′ is provided with multiple heat sink ribs for increasing the surface area of the heat sink 14′. By increasing the surface area of the heat sink 14, the heat sink capacity for transporting heat from the diode area is increased. The heat sink part 14″ is located below the heat sink part 14′ leaving a distance between the two heat sink parts, 14′ and 14″. Heat sink 14″ is also provided with ribs. The two heat sink parts 14′ and 14″ are connected thermally through central rod 16. Heat sink 4 as well as the the central rod 16 are made from a thermally conducting material. The central rod 16 is extending from the central diode position of the diode area 11 above the heat sink 14′, whereby the central rod 16 is capable of directing heat produced by the diodes 18 away from the diode area 11 and into the heat sink parts 14′ and 14″. Apart from functioning as heat sinks the two heat sink parts, 14′ and 14″, may also serve as anchor means for other elements in the portable torch. For example the heat sink part 14″ may serve as anchor means for the battery holder thereby the inner torch assembly may be connected as one unit.

A cross section of the heat sink is shown in FIG. 13.

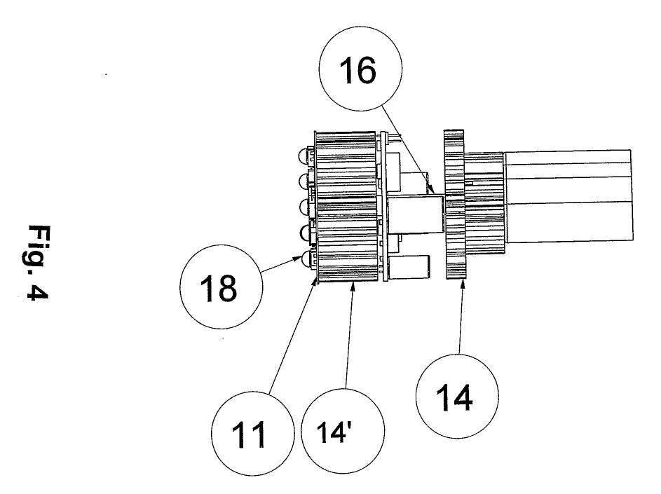

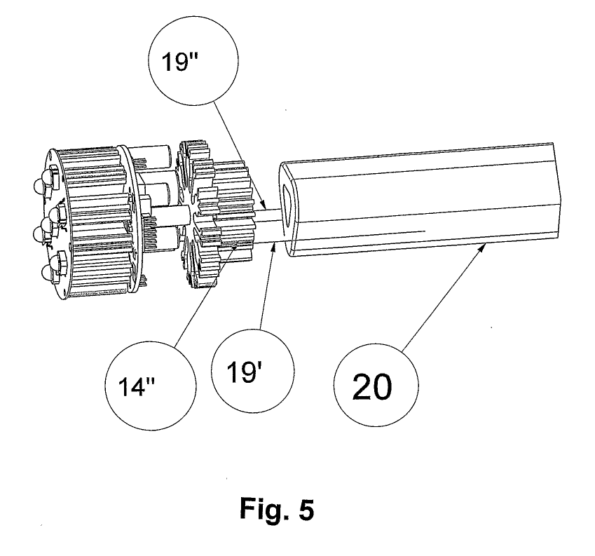

In FIG. 5 the lower heat sink part 14″ is shown. Extending from the heat sink part 14″ are two battery holder rods 19′ and 19″. The battery holder rods 19′ and 19″ hold and position the battery unit 20 in a fixed relationship with the remaining elements of the torch, whereby the inner torch assembly may be seen as one unit.

FIG. 6 shows the inner torch assembly 26 with the transparent area 6 of the first cap as one unit. The inner torch assembly 26 consists of diodes 18 positioned on the diode area 11. Below the diode area 11 are the two heat sink parts 14′ and 14″ spaced apart from each other. The two heat sink parts, 14′ and 14″, are connected through central rod 16. The battery unit 20 is attached through battery holder to the heat sink part 14″. During assembling the inner torch assembly is inserted into the case of the portable torch through the first end of the portable torch. Once the inner torch assembly is in place the first cap and the second cap may be attached thereby closing the portable torch.

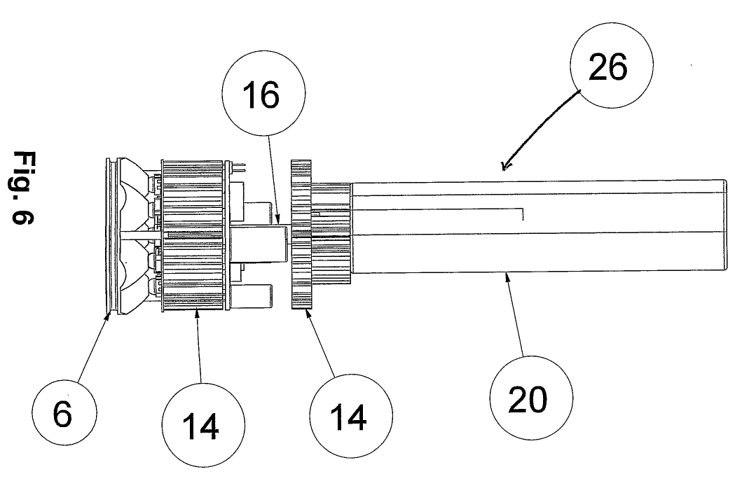

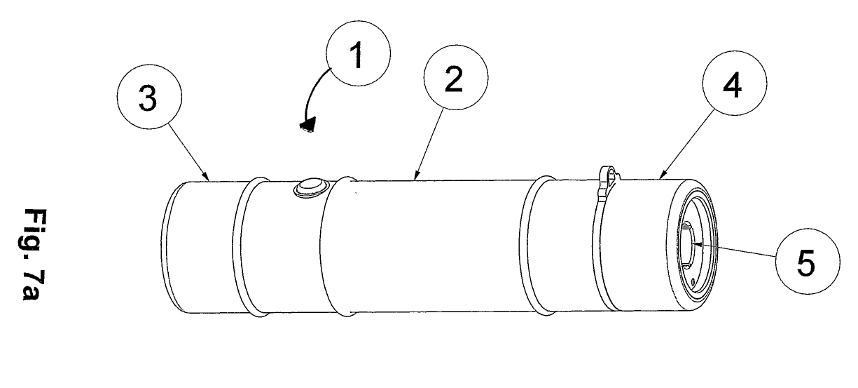

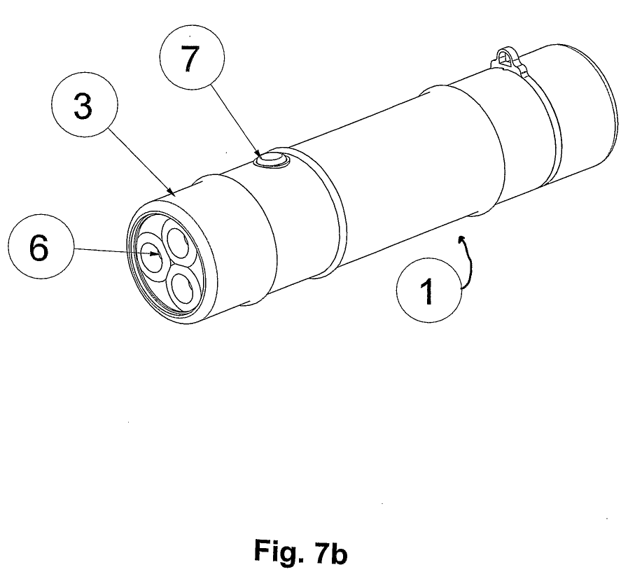

FIG. 7a shows an alternative embodiment of the portable torch 1 according to the invention seen from the second end of the torch. The torch 1 has a case 2 and a first end being closed with a first cap 3 and a second end being closed with a second cap 4. The second cap 4 is provided with connection means 5 for connecting a second battery-driven device to the portable torch 1, whereby the portable torch 1 serves as a battery-tank for the second battery-driven device. FIG. 7b shows the portable torch 1 seen from the first end of the torch. Thereby the transparent area 6 of the first cap 3 is shown. The transparent area 6 comprises seven recesses corresponding to seven diodes. In each recess a lens is located (not shown). The portable torch 1 further provides one switch 7 for controlling the function of the portable torch 1. In FIG. 7c the portable torch 1 is seen from the side showing the first cap 3, the second cap 4 as well as the switch 7.

FIG. 8a shows the outer surface of transparent area 6 of the first cap. The transparent area 6 is provided with three recesses 9, a recess 9 for each diode of the portable torch. In the bottom of the recess 9 a lens 10 is provided. By arranging the lens 10 in a bottom of a recess 9, the risk for scratches on the lens 10 is minimized. The transparent area 6 is positioned in relation to a diode area (not shown) below the transparent area 6 by means of fastening rods 8. FIG. 2b shows the inner surface of the transparent area 6 of FIG. 2a. The lens 10 is shown positioned in the bottom of the recesses. Three fastening rods 8 are provided for positioning the transparent area 6.

FIG. 9 shows a diode area 11 having three diode positions 12 for positioning diodes. Diodes are provided with power from the power source through circuit 13. A heat sink 14 is positioned below the diode area 11.

A cross section of the heat sink is shown in FIG. 13.

FIG. 10 shows the inner torch assembly 26 with the transparent area 6 of the first cap as one unit. The inner torch assembly 26 consists of diodes 18 positioned on the diode area 11. Below the diode area 11 are the two heat sink parts 14′ and 14″ spaced apart from each other. The two heat sink parts, 14′ and 14″, are connected through central rod 16. The battery unit 20 is attached through battery holder to the heat sink part 14″. During assembling the inner torch assembly is inserted into the case of the portable torch through the first end of the portable torch. Once the inner torch assembly is in place the first cap and the second cap may be attached thereby closing the portable torch.

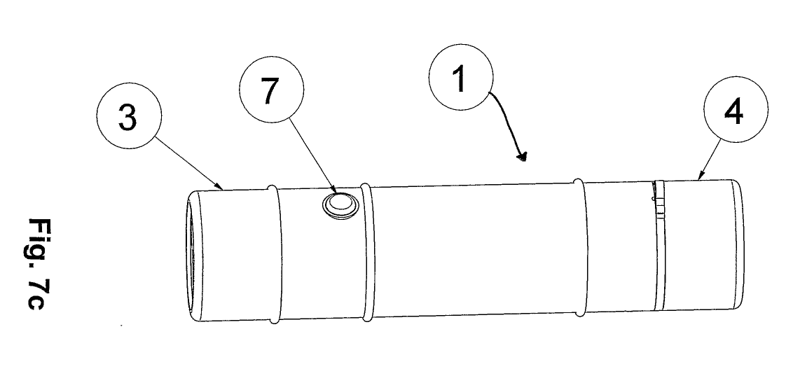

FIG. 11a shows a tail-light socket 22 to be connected to the connection means of the second cap of the portable torch. The tail-light is battery-driven and provided with power from the battery of the portable torch. In the shown embodiment the tail-light is connected to the portable torch through a cable having connectors at both ends. Connector 23 is shown connected to the tail-light socket 22. Diode 18 is positioned centrally on the tail-light socket 22. FIG. 11b shows the tail-light socket of FIG. 11a wherein a transparent cap 24 is arranged to cover the diode on the tail-light socket 22. The connector 23 is preferably provided with small recesses for improving the grip.

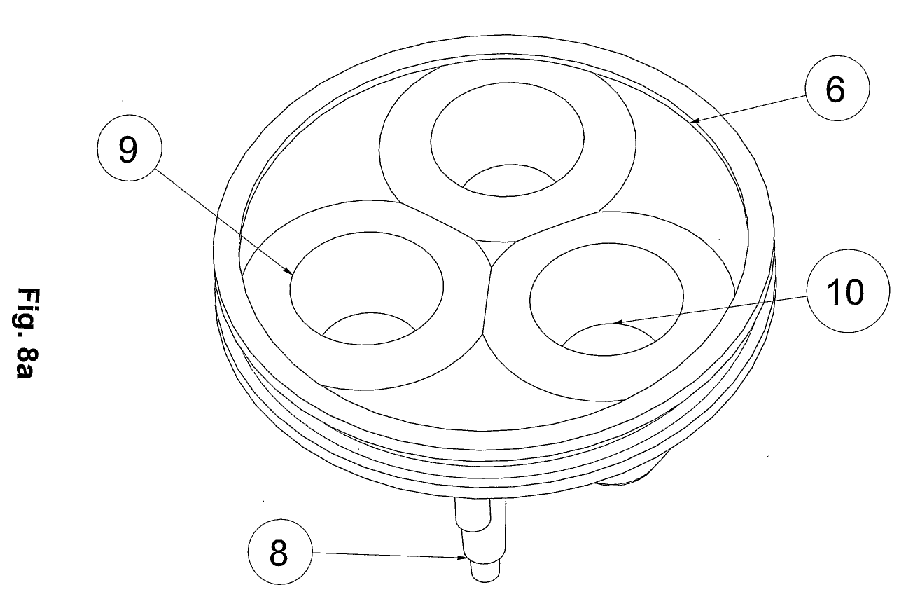

FIG. 12 shows a tail-light socket 22 with transparent cap 24, cable 25 with connectors 23′ and 23″ as well as the second end 4 of the portable torch. Connector 23′ is connected to the tail-light socket 22 and connector 23″ may be connected to the connection means of the second cap 4 of the portable torch. Thereby the tail-light may be used at a distance from the portable torch, such as positioned in a cap of the user, while still receiving power from the battery of the portable torch. The tail-light may be of any colour and/or function. Thereby the tail-light for example may be friend-foe identification while the portable torch as such serves as illumination source. The tail-light may also be strobing while the portable light has a continuous illumination source.

In FIG. 13a one embodiment of a heat sink cross section is shown. The heat sink 14 comprises a body part 29 connected to a variety of ribs 30. The heat sink 14 also comprises bearing surfaces 31 for the diodes, and a central hole 32 through which a central rod (not shown) may extend dissipating heat from the diode area to the heat sink 14. The heat sink 14 is furthermore provided with means 33 for fastening the printed circuit board to the heat sink 14 thereby providing a compact inner torch assembly. FIG. 13b shows an alternative embodiment of the heat sink 14, having body part 29, ribs 30, bearing surfaces 31 for the diodes, and a central hole 32 as well as means 33 for fastening the printed circuit board to the heat sink 14.

FIG. 14a shows the switch arrangement 27 in greater detail. Switch 7 is located in switch recess 38 in the switch arrangement 27. The switch 7 has a flange 42 to abut the floor 43 of the recess 38 to limit the insertion of the switch 7 into torch body. The switch 7 is held in place in the switch recess 38 by means of lock clips 34. The switch 7 is biased by means of spring 36 located beneath the switch 7. The switch arrangement 27 is waterproof due to a valve in the form of an O-ring 37 located in the well 35. FIG. 14b shows an exploded view of the switch 7 in greater detail.

FIG. 14c shows the switch during valve ventilation, wherein increase in pressure in the torch inner body forces the switch 7 outwards to the shoulder 40 of the lock clip. Thereby the O-ring 37 moves outwards as well allowing valve ventilation of the inner torch body.

In FIG. 14d, the switch arrangement of FIG. 14a-c is shown with the addition of magnet 41. Through magnet 41, it is possible to attach the torch to a surface. When the torch is attached to a surface, the switch 7 is pressed inwards thereby activating the power source.

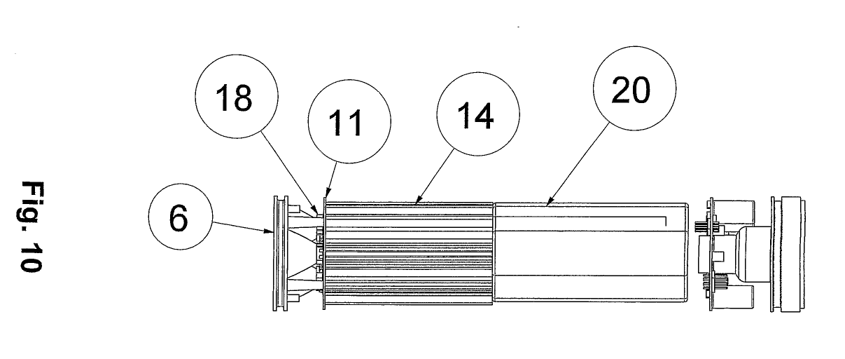

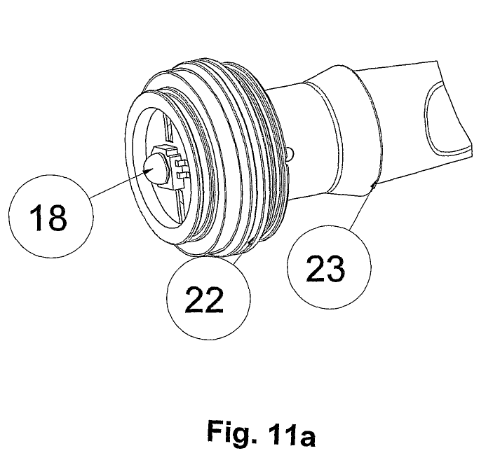

In FIG. 15a shows the case 2 of a second battery-driven device having one open end for receiving a cap having a transparent diode area. In the closed end of the second battery-driven device one or more switches 7 may be arranged.

FIG. 15b shows a more detailed drawing of the switches 7 of the case discussed in FIG. 15a. The switch 7 comprises switch recess 38′, 38″ as well as other details of the switch shown in FIG. 14a-d, including valve mechanism.

FIG. 15c shows a cap 3 for the battery-driven device of FIG. 15a comprising a transparent diode area 6. Said cap 3 is capable of fitting into the open end of the case 2 of the battery-driven device of FIG. 15a, as well as into the connection means of the second cap 4 of the portable torch. Thereby the cap 3 may be used with the portable torch as well as with the second battery-driven device.

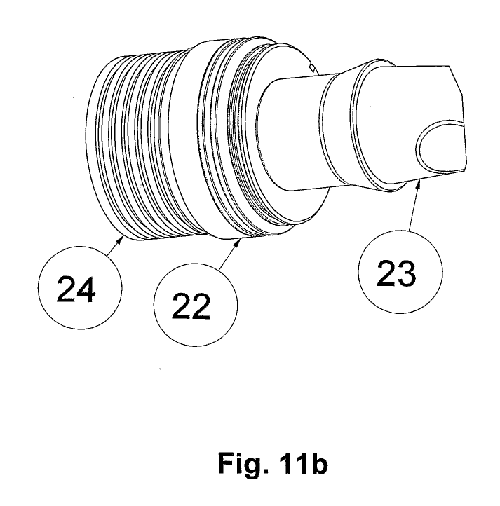

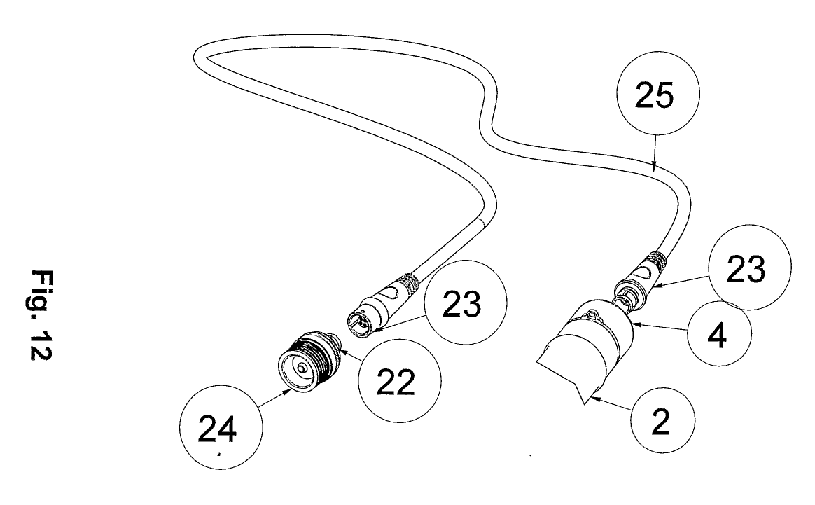

FIG. 16a shows the portable torch 1 according to the invention seen from the side of the torch. The torch 1 has a case 2 and a first end being closed with a first cap 3 and a second end being closed with a second cap 4. The first cap 3 is locked to the case 2 by means of engaging means 44 having a recess capable of engaging protrusion 45 on the case. FIG. 16b shows the first cap 3 and the first end of the case 2, wherein the first cap 3 is locked to the case. FIG. 16c shows the same cap as FIG. 16b, where the first cap 3 is in an un-locked position, in that the engaging means 44 do not engage with protrusion 45. In this position the first cap 3 may be rotated and released from the case 2.

FIG. 17 shows the portable torch 1 according to the invention seen from the side of the torch. The torch 1 has a case 2 and a first end being connectable to cable 46 through connecting means 47, and a second end being closed with a second cap 4. The first cap 3 having the transparent area 6 is connectable to the other end of the cable 46 through connecting means 48. The light emitting units of the first cap 3 are supplied with energy from a battery positioned in the case 2 through cable 46. Furthermore, any instructions from the first and/or the second processor may also be transmitted through cable 46. A connectable unit may be connected to the second end of the case 2, in the present case a Global Positioning Signal unit 49 is connectable to the second end.

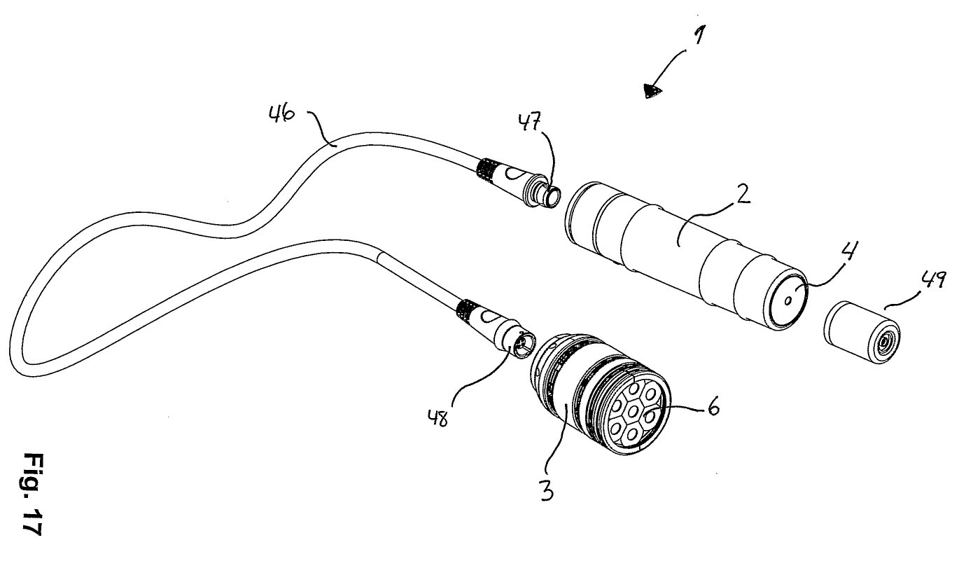

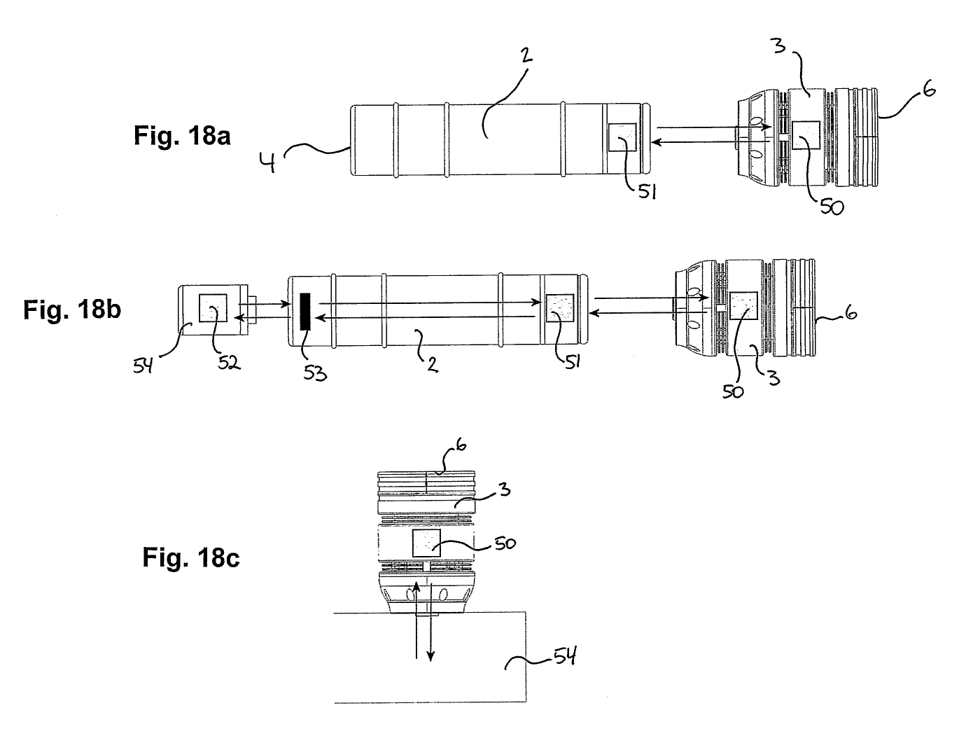

FIG. 18a shows the portable torch 1 according to the invention seen from the side of the torch. The torch 1 has a case 2 and a first end being closed with a first cap 3 and a second end being closed with a second cap 4. In the first cap 3 the second microprocessor is located in communication with the first microprocessor 51 located in the case 2. FIG. 18b shows the torch of FIG. 18a, wherein the first microprocessor 51 communicates through an infrared port 53 to an external computer (not shown). Furthermore, a connectable unit 54 comprising yet another microprocessor 52 may be connected to the second cap 4 of the case 2. Said microprocessor 52 may communicate with the other microprocessors 50, 51 of the torch and/or may communicate through the infrared port 53. FIG. 18c shows the first cap 3 positioned in a console 55, wherein the second microprocessor 50 is programmed for example from a computer (not shown).

It is to be understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

1. A portable torch comprising
a case having a first end and a second end, and a first cap having a transparent area,
illumination means having an illumination area comprising at least one light emitting unit (LEU) arranged to emit light through the transparent area of the first cap,
a power source comprising a battery holder,
means for activating said power source,
at least a first microprocessor comprising means for controlling the functionality of the torch, means for communicating with at least one external control unit, and means for storing received program settings and data from said external control unit
wherein the functionality of the torch is determined by the settings and programs of said first microprocessor.

2. A portable torch according to claim 1, wherein the outer parts of said first cap or said releasably locked head are made in a material that exhibits a low thermal conductivity

3. A portable torch according to any of claims 1-2, further comprising a second microprocessor comprising communicative means for communicating with said first microprocessor and communicative means for communicating with at least one external control unit, and wherein the first microprocessor furthermore comprises means for communicating with other microprocessors, and means for storing received program settings and data from said other microprocessors,

4. A portable torch according to any of the preceding claims, wherein said first cap is replaced by a releasably locked head, wherein said releasably locked head comprises rotation preventing means that essentially prevents rotation of the releasably locked head relative to the case around the longitudinal axis of the case when the releasably locked head is locked onto said case.

5. A portable torch according to any of preceding claims, further comprising a removable cover encasing at least the transparent area of said first cap or said releasably locked head providing means for arranging means for altering the optical properties of a light beam emitted out through the transparent area of said first cap or said releasably locked head

6. A portable torch according to any of the claims preceding claims wherein said at least one light emitting unit (LEU) comprises at least one light emitting diode (LED) arranged to emit light out of the first open end and through the transparent area of the first cap or said releasably locked head.

7. A portable torch according to any of the preceding claims further comprising a heat sink arranged to transport heat from the light emitting units or said light emitting diodes, wherein said heat sink comprises a central part of a first material, and at least one peripheral part of a second material, and said first material is different from said second material.

8. A portable torch according to any of the claims preceding claims, wherein said second end is open and covered by a second cap.

9. The portable torch according to any of preceding claims 5-8, wherein said means for altering the optical properties comprises at least one optical element for diffusing said light beam and/or for reducing the intensity of said beam.

10. The portable torch according to any of preceding claims 5-9, wherein said means for altering the optical properties comprises at least one optical element for changing the hue and/or the colour and/or the temperature of said beam.

11. The portable torch according to any of preceding claims 5-10, wherein said cover comprises means for protecting the transparent area of said releasably locked head

12. The portable torch according to any of the preceding claims wherein
said releasably locked head or said first cap sealingly covers the first open end and said second cap sealingly covers the second open end
said means for activating said power source operatively associated with said case comprises one or more switch buttons sealingly arranged on the case.

13. The torch according to any of preceding claims, wherein said means in said first microprocessor for communicating with said at least one external control unit comprises means for wired communication, such as a suitable console, parallel cables, serial cables, and USB cables.

14. The torch according to any of preceding claims, wherein said means on said first microprocessor for communicating with said at least one external control unit comprises means for wireless communication, such as a Bluetooth connection, radio signals, WiFi, and Infrared communication.

15. The torch according to any of preceding claims, wherein said second cap and/or said case provide means for connecting said first microprocessor to said external control unit.

16. The portable torch according to any of preceding claims, wherein said means in said at least a first microprocessor for communicating with other microprocessors such as said second microprocessor, comprise means for wired communication using a cable and/or wire suitable for communication between two units.

17. The portable torch according to any of preceding claims, wherein said means in said at least a first microprocessor for communicating with other microprocessors such as said second microprocessor, comprise means for wireless communication such as a Bluetooth connection, radio signals, WiFi, and Infrared communication

18. The portable torch according to any of preceding claims, wherein said communicative means in said second microprocessor for communicating with said first microprocessor and/or said at least one external control unit, comprise means for wired communication using a cable and/or wire suitable for communication between two units.

19. The portable torch according to any of preceding claims, wherein said communicative means in said second microprocessor for communicating with said first microprocessor and/or said at least one external control unit, comprise means for wireless communication such as a Bluetooth connection, radio signals, WiFi, and Infrared communication.

20. The portable torch according to any of preceding claims, wherein transmitters and/or receivers that are used to establish a wireless link between said at least a first microprocessor and a second microprocessor and/or between said at least one external control unit and said second microprocessor are located off said at least a first microprocessor and a second microprocessor.

21. The torch according to any of preceding claims, wherein said second cap and/or said case provide means for connecting the second microprocessor to the external control unit.

22. The torch according to any of preceding claims 3-21, wherein said second microprocessor is located in said releasably locked head.

23. The torch according to claim 22, wherein said means for connecting the second microprocessor to the external control unit comprise means for connecting said releasable locked head comprising the second microprocessor to a console equipped with means for connecting to the external control unit.

24. The torch according to any of the preceding claims, wherein at said at least first microprocessor comprises a non-volatile memory such as an EPROM or an EEPROM.

25. The torch according to any of claims 3-25, wherein at said second microprocessor comprises a non-volatile memory such as an EPROM or an EEPROM.

26. The torch according to any of claims the preceding claims, wherein said external control unit comprise an interactive tool, such as a personal computer.

27. The torch according to any of preceding claims, wherein at said first microprocessor and said second microprocessor comprise means for communicating when the torch is turned on, thereby providing means for an adjustment of the functionality of said first microprocessor and thereby the torch based on data and program instructions stored in said second microprocessor.

28. The torch according to any of preceding claims 4-28, wherein said rotation preventing ensures that the rotation of the releasably locked head around the longitudinal axis of the case is below 10°, preferably below 5°, more preferably below 2°, more preferably below 1°.

29. The torch according to any of preceding claims 3-29, wherein said rotation preventing means of the head interacts with rotation preventing means of the case and/or rotation preventing means of the inner torch assembly.

30. The torch according to any of claims 3-29, wherein said rotation preventing means of the releasable locked head comprise at least one hole extending parallel to the longitudinal axis of the case, where at least one solid rod anchored in the inner torch assembly and extending parallel to the longitudinal axis of the case can be inserted in said at least one hole, and wherein the diameter of said at least one hole essentially is identical to the diameter of said at least one rod.

31. The torch according to any of claims 3-30, wherein said releasably locked head comprises a front ring, a turn ring, and a middle ring, wherein said turn ring comprise means for attaching said rods to the ring.

32. The portable torch according to any of the preceding claims, wherein the illumination means comprises at least three LEDs arranged and the heat sink is connected to the diode area through a central thermally conducting rod.

33. The portable torch according to any of the preceding claims, wherein the central rod includes at least a part of the battery holder.

34. The portable torch according to any of the preceding claims, wherein the battery holder comprises at least two pins connected to a central pin.

35. The portable torch according to any of the preceding claims, wherein the LEDs are arranged on a support with socket means for providing electrical power between the power source and the LEDs.

36. The portable torch according to any of the preceding claims, further comprising control means for maintaining a substantially constant light output from the illumination means.

37. The portable torch according to claim 36, wherein the control means includes feedback means for measuring temperature of LEDs and means for regulating light intensity of the LEDs.

38. The portable torch according to any of the preceding claims, wherein the control means are capable of activating the power supply to the illumination means independent from activating the power supply to the second battery-driven device connectable to the second cap.

39. The portable torch according to any of the preceding claims, wherein a cap comprising a diode area of the battery-driven device is connectable to the second cap.

40. The portable torch according to any of the preceding claims, wherein the battery-driven device connectable to the second cap may be a flash light, a second torch, a coloured light, an ultraviolet light, an infrared light, and/or a Global Positioning System.

41. The portable torch according to any of the preceding claims, wherein the control means includes means for monitoring the device connected to the second cap.

42. A modular kit, said kit comprising at least one portable torch as defined in any of the claims 1-41, and at least one second battery-driven device, wherein said second battery-driven device is capable of being connected to the portable torch.

43. The modular kit according to claim 42, wherein the portable torch is capable of functioning as a battery-tank for a second battery-driven device.

44. The modular kit according to any of the preceding claims 42-43, wherein a second cap of the portable torch comprises means for connecting the at least one second battery-driven device.

45. The modular kit according to any of the preceding claims 42-44, wherein the power source of the portable torch supplies power to the illumination means of the portable torch and to the second battery-driven device connectable to the portable torch.

46. The modular kit according to any of the preceding claims 42-45, wherein the control means are capable of activating the power supply to the illumination means of the portable torch independent from activating the power supply to the second battery-driven device connectable to the portable torch.

47. The modular kit according to any of the preceding claims 42-46, wherein a cap comprising a diode area of the battery-driven device is connectable to the second end of the portable torch.

48. The modular kit according to any of the preceding claims 42-47, wherein the second battery-driven device connectable to the portable torch may be a flash light, a second torch, a coloured light, an ultraviolet light, or an infrared light.

49. The modular kit according to any of the preceding claims 42-48, wherein the control means includes means for monitoring the device connected to the portable torch.

50. A device, said device being adapted for connecting to a portable torch as defined in any of the claims 1-49, wherein the device is adapted for communicating with an external control unit through a communicative means of the torch.

51. The device according to claim 50, wherein the portable torch is capable of functioning as a battery-tank for the device.

52. The device according to any of the preceding claims 50-51, being a Global Positioning System.

53. The device according to any of the claims 50-52, wherein the device is controlled through a first and/or a second microprocessor of the torch.
